(19) United States
(12) Patent Application Publication
(10) Pub. No.: US 2025/0356316 A1
(43) Pub. Date: Nov. 20, 2025

(54) COLLABORATIVE ARTIFICIAL INTELLIGENT (AI) AGENT SYSTEMS WITH COORDINATORS/RECOMMENDATIONS FOR SHARED APPLICATIONS AND METHODS THEREOF

(71) Applicant: Affle (India) Limited, India, Gurugram (IN)

(72) Inventors: ANUJ KHANNA SOHUM, Singapore (SG); CHARLES YONG JIEN FOONG, Templestowe (AU); MADHUSUDANA RAMAKRISHNA, Singapore (SG)

(73) Assignee: Affle (India) Limited, India, Gurugram (IN)

(21) Appl. No.: 19/209,196

(22) Filed: May 15, 2025

(30) Foreign Application Priority Data
May 15, 2024 (IN) IN202311077692

(51) Int. Cl. G06Q 10/10; G06F 11/34; G06F 16/21

(52) U.S. Cl. CPC G06Q 10/103; G06F 11/3438; G06F 16/213

(57) ABSTRACT

In an embodiment, the present invention discloses a method for collaborating one or more Artificial Intelligent (AI) agent systems with a plurality of coordinators to perform a task. The method includes receiving, by a system AI agent, a request from a user device for performing a task. The method includes determining, by the system AI agent, a coordinator amongst the plurality of coordinators configured to augment the request to be implemented with the request. The method includes extracting, by a support AI agent, relevant information associated with the request from within the system and outside the system. The method includes obfuscating, by a local AI agent, information associated with the system to prevent a data leakage, while the relevant information is being extracted. The method includes performing, by the system AI agent, the task associated with the request based on the relevant information. The system AI agent generates an output augmented with another coordinator amongst the plurality of coordinators.

### CROSS-REFERENCE TO RELATED APPLICATIONS

This patent application claims priority to Indian Patent Application No. IN 202311077692, filed May 15, 2024, entitled “COLLABORATIVE ARTIFICIAL INTELLIGENT (AI) AGENT SYSTEMS WITH COORDINATORS/RECOMMENDATIONS FOR SHARED APPLICATIONS AND METHODS THEREOF,” and assigned to the assignee hereof.

The disclosure of the prior application is considered part of and is incorporated by reference in this patent application.

### TECHNICAL FIELD

Embodiments of the present disclosure generally relate to artificial intelligence (AI) based systems and, more particularly, to collaborative artificial intelligent (AI) agent systems with coordinators for shared applications and methods thereof.

### BACKGROUND

In the current interconnected world, the proliferation of smart devices and applications has revolutionized the way people interact with technology. The emergence of the Internet of Things (IoT) has led to innovative solutions for various aspects of daily life, including home management, social interactions, and collaborative workspaces. One significant area of focus in this technological landscape is the development of shared applications, where multiple users collaborate and interact within a unified digital environment.

Traditional shared applications often face challenges in managing interactions among multiple users. In scenarios such as shared kitchen appliances, collaborative planning tools, or multifunctional smart devices, efficient coordination becomes paramount. Ensuring seamless collaboration and preventing conflicts in such shared environments necessitates advanced communication protocols and intelligent agents that can handle diverse inputs from multiple sources. Additionally, as the complexity of these shared applications grows, there is an increasing need for structured communication interfaces. In light of these challenges and opportunities, there is a pressing need for advanced systems and methods that can facilitate collaborative interactions within shared applications, to enhance user experiences, promote efficient collaboration, and ensure the seamless operation of shared applications in our increasingly interconnected digital world.

Consequently, there is a need for improved collaborative artificial intelligent (AI) agent systems with coordinators for shared applications and methods thereof, to address at least the aforementioned mentioned issues of the prior arts.

### OBJECTS OF THE INVENTION

A general objective of the present disclosure is to provide a system and a method for collaborating one or more Artificial Intelligent (AI) agent systems with a plurality of coordinators to perform a task. The further objectives of present disclosure are discussed below.

Another objective of the present disclosure is to provide a system having AI agents communicating with one another.

Another objective of the present disclosure is to provide a system utilizing a coordinator to augment an input received by the system.

### SUMMARY OF THE INVENTION

Solution to one or more drawbacks of existing technology, and additional advantages are provided through the present subject matter. Additional features and advantages are realized through the technicalities of the present subject matter. Other embodiments and aspects of the subject matter are described in detail herein and are considered to be a part of the claimed subject matter.

In an embodiment, the present invention discloses a method for collaborating one or more Artificial Intelligent (AI) agent systems with a plurality of coordinators to perform a task. The method includes receiving, by a system AI agent, a request from a user device for performing a task. The system AI agent processes the request. The method includes determining, by the system AI agent, a coordinator amongst the plurality of coordinators configured to augment the request to be implemented with the request. The request and the coordinator is communicated to a support AI agent. The method includes extracting, by the support AI agent, relevant information associated with the request from within the system and outside the system. The relevant information is consolidated by the coordinator. The method includes obfuscating, by a local AI agent, information associated with the system to prevent a data leakage, while the relevant information is being extracted. The method includes performing, by the system AI agent, the task associated with the request based on the relevant information. The system AI agent generates an output augmented with another coordinator amongst the plurality of coordinators.

In an embodiment, the present invention discloses a system for collaborating one or more Artificial Intelligent (AI) agent systems with a plurality of coordinators to perform a task. The system includes a system AI agent configured to receive a request from a user device for performing a task. The system AI agent processes the request. The system AI agent is configured to determine a coordinator amongst the plurality of coordinators configured to augment the request to be implemented with the request. The request and the coordinator is communicated to a support AI agent. The support AI agent is configured to extract relevant information associated with the request from within the system and outside the system. The relevant information is consolidated by the coordinator. The method includes obfuscating, by a local AI agent, information associated with the system to prevent a data leakage, while the relevant information is being extracted. The system AI agents configured to perform the task associated with the request based on the relevant information. The system AI agent generates an output augmented with another coordinator amongst the plurality of coordinators.

### BRIEF DESCRIPTION OF THE DRAWINGS

The disclosure will be described and explained with additional specificity and detail with the accompanying figures in which:

FIG. 1 illustrates an exemplary block diagram representation of a network architecture implementing a collaborative artificial intelligent (AI) agent system with coordinators for shared applications, in accordance with an embodiment of the present disclosure;

FIG. 2 illustrates an exemplary block diagram representation of a computer implemented system, such as those shown in FIG. 1, capable of implementing collaborative artificial intelligent (AI) agent systems with coordinators for shared applications, in accordance with an embodiment of the present disclosure;

FIG. 3 illustrates an exemplary flow diagram representation of interaction of supporting AI agent, a system AI agent, and a local AI agent including a plurality of artificial intelligence (AI) agents, in accordance with an embodiment of the present disclosure; and

FIG. 4 illustrates an operational flow diagram depicting a method for collaborating one or more Artificial Intelligent (AI) agent systems with a plurality of coordinators to perform a task, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

Embodiments of the present disclosure provide collaborative artificial intelligent (AI) agent systems with coordinators for shared applications and methods thereof.

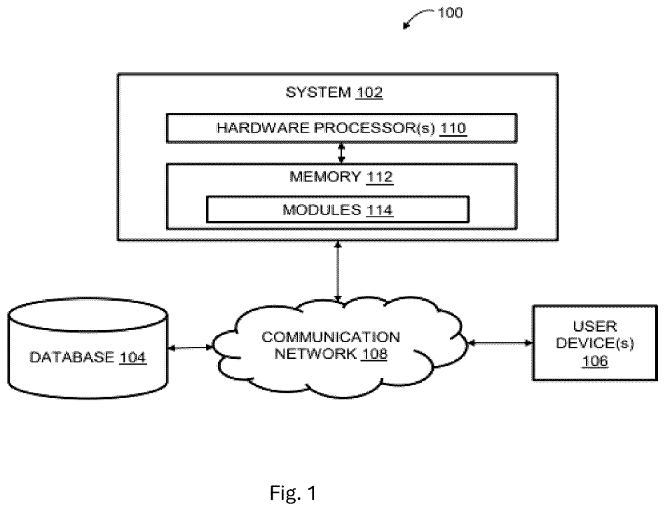

Referring now to the drawings, and more particularly to FIG. 1 through FIG. 4, where similar reference characters denote corresponding features consistently throughout the figures, there are shown preferred embodiments, and these embodiments are described in the context of the following exemplary system and/or method.

FIG. 1 illustrates an exemplary block diagram representation of a network architecture 100 implementing a collaborative artificial intelligent (AI) agent 102 (herein after referred to as the system 102) with coordinators for shared applications, in accordance with an embodiment of the present disclosure. According to FIG. 1, the network architecture 100 includes the system 102, a database 104, and one or more user devices 106. The one or more user devices 106 may be associated with one or more users, and communicatively coupled to the system 102 via a communication network 108. In an exemplary embodiment of the present disclosure, the user devices 106 may include a laptop computer, desktop computer, tablet computer, smartphone, wearable device, a digital camera, and the like. Further, the communication network 108 may be a wired network or a wireless network. The system 102 may be at least one of, but not limited to, a central server, a cloud server, a remote server, an electronic device, a portable device, and the like. Further, the system 102 may be communicatively coupled to the database 104, via the communication network 108. The database 104 may include, but is not limited to, personal data, health data, lifestyle data, finance data, device data, any other data, and combinations thereof. The database 104 may be any kind of databases/repositories such as, but are not limited to, relational database, dedicated database, dynamic database, monetized database, scalable database, cloud database, distributed database, any other database, and combination thereof.

Further, the user device 106 may be associated with, but not limited to, a user, an individual, an administrator, a vendor, a technician, a worker, a specialist, a healthcare worker, an instructor, a supervisor, a team, an entity, an organization, a company, a facility, a bot, any other user, and combination thereof. The entities, the organization, and the facility may include, but are not limited to, a hospital, a healthcare facility, an exercise facility, a laboratory facility, an e-commerce company, a merchant organization, an airline company, a hotel booking company, a company, an outlet, a manufacturing unit, an enterprise, an organization, an educational institution, a secured facility, a warehouse facility, a supply chain facility, any other facility and the like. The user device 106 may be used to provide input and/or receive output to/from the system 102, and/or to the database 104, respectively. The user device 106 may present to the user one or more user interfaces for the user to interact with the system 102 and/or to the database 104 for collaborative artificial intelligent (AI) agent system with coordinators for shared applications need. The user device 106 may be at least one of, an electrical, an electronic, an electromechanical, and a computing device. The user device 106 may include, but is not limited to, a mobile device, a smartphone, a personal digital assistant (PDA), a tablet computer, a phablet computer, a wearable computing device, a virtual reality/augmented reality (VR/AR) device, a laptop, a desktop, a server, and the like.

Further, the system 102 may be implemented by way of a single device or a combination of multiple devices that may be operatively connected or networked together. The system 102 may be implemented in hardware or a suitable combination of hardware and software. The system 102 includes one or more hardware processor(s) 110, and a memory 112. The memory 112 may include a plurality of modules 114. The system 102 may be a hardware device including the hardware processor 110 executing machine-readable program instructions for collaborative artificial intelligent (AI) agent system with coordinators for shared applications. Execution of the machine-readable program instructions by the hardware processor 110 may enable the proposed system 102 to implement a collaborative artificial intelligent (AI) agent system with coordinators for shared applications. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors. The one or more hardware processors 110 may include, for example, microprocessors, microcomputers, microcontrollers, digital signal processors, central processing units, state machines, logic circuits, and/or any devices that manipulate data or signals based on operational instructions. Among other capabilities, hardware processor 110 may fetch and execute computer-readable instructions in the memory 112 operationally coupled with the system 102 for performing tasks such as data processing, input/output processing, and/or any other functions. Any reference to a task in the present disclosure may refer to an operation being or that may be performed on data.

Though few components and subsystems are disclosed in FIG. 1, there may be additional components and subsystems which is not shown, such as, but not limited to, ports, routers, repeaters, firewall devices, network devices, databases, network attached storage devices, servers, assets, machinery, instruments, facility equipment, emergency management devices, image capturing devices, sensors, any other devices, and combination thereof. The person skilled in the art should not be limiting the components/subsystems shown in FIG. 1. Although FIG. 1 illustrates the system 102, and the user device 106 connected to the database 104, one skilled in the art can envision that the system 102, and the user device 106 can be connected to several user devices located at various locations and several databases via the communication network 108.

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 102 as is unique to the present disclosure or necessary for an understanding of the present disclosure is depicted and described. The remainder of the construction and operation of the system 102 may conform to any of the various current implementations and practices that were known in the art.

In an exemplary embodiment, the system 102 may manage shared applications, by using device agents. The device agents may be configured to facilitate collaborative interactions in a shared application, including multiple users contributing items to the application and planning item usage. The device agents may receive and process inputs from multiple users to manage the shared application efficiently.

In an exemplary embodiment, the system 102 may implement coordinators designed to augment inputs provided to device agents and consolidate incoming information to enhance collaborative functions within the shared application. The coordinators may be further configured to streamline output generated by the device agents, ensuring seamless operation of the shared application.

In an exemplary embodiment, the system 102 may implement system agents to facilitate communication between different components of the system via fixed interfaces, including application programming interfaces (APIs).

In an exemplary embodiment, the system 102 may implement local agents configured to compare information between different agents, identifying similarities to optimize system performance. The local agents may maintain a record of information shared among agents and systems to ensure data integrity.

In an exemplary embodiment, the system 102 may implement a throttling mechanism to control the amount of information distributed to an agent or system within a specific timeframe, preventing excessive requests and safeguarding against potential malicious activities.

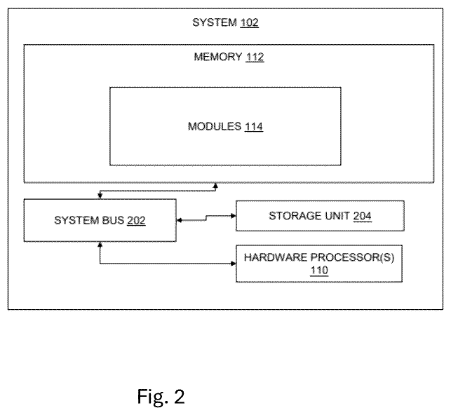

FIG. 2 illustrates an exemplary block diagram representation of a computer implemented system 102, such as those shown in FIG. 1, capable of implementing collaborative artificial intelligent (AI) agent systems with coordinators for shared applications, in accordance with an embodiment of the present disclosure. The system 102 may also function as a computer-implemented system/server (hereinafter referred to as the system 102). The system 102 comprises the one or more hardware processors 110, the memory 112, and a storage unit 204. The one or more hardware processors 110, the memory 112, and the storage unit 204 are communicatively coupled through a system bus 202 or any similar mechanism. The memory 112 comprises a plurality of modules 114 in the form of programmable instructions executable by the one or more hardware processors 110.

The one or more hardware processors 110, as used herein, means any type of computational circuit, such as, but not limited to, a microprocessor unit, microcontroller, complex instruction set computing exceptionally long processor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 110 may also include embedded controllers, such as generic or programmable logic devices or arrays, application-specific integrated circuits, single-chip computers, and the like.

The memory 112 may be a non-transitory volatile memory and a non-volatile memory. The memory 112 may be coupled to communicate with the one or more hardware processors 110, such as being a computer-readable storage medium. The one or more hardware processors 110 may execute machine-readable instructions and/or source code stored in the memory 112. A variety of machine-readable instructions may be stored in and accessed from the memory 112. The memory 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory 112 includes the plurality of modules 114 stored in the form of machine-readable instructions on any of the above-mentioned storage media and may be in communication with and executed by the one or more hardware processors 110.

The storage unit 204 may be a cloud storage or a repository such as those shown in FIG. 1. The storage unit 204 may store, but is not limited to, telemetry signals, alerts, operations, health status, any other data, and combinations thereof. The storage unit 204 may be any kind of databases/repositories such as, but are not limited to, relational database, dedicated database, dynamic database, monetized database, scalable database, cloud database, distributed database, any other database, and combination thereof.

In an exemplary embodiment, the plurality of modules 114 may manage shared applications, by using device agents. The device agents may be configured to facilitate collaborative interactions in a shared application, including multiple users contributing items to the application and planning item usage. The device agents may receive and process inputs from multiple users to manage the shared application efficiently.

In an exemplary embodiment, the plurality of modules 114 may implement coordinators designed to augment inputs provided to device agents and consolidate incoming information to enhance collaborative functions within the shared application. The coordinators may be further configured to streamline output generated by the device agents, ensuring seamless operation of the shared application.

In an exemplary embodiment, the plurality of modules 114 may implement system agents to facilitate communication between different components of the system via fixed interfaces, including application programming interfaces (APIs).

In an exemplary embodiment, the plurality of modules 114 may implement local agents configured to compare information between different agents, identifying similarities to optimize system performance. The local agents may maintain a record of information shared among agents and systems to ensure data integrity.

In an exemplary embodiment, the plurality of modules 114 may implement a throttling mechanism to control the amount of information distributed to an agent or system within a specific timeframe, preventing excessive requests and safeguarding against potential malicious activities.

Within these shared environments, the use of device agents has gained traction as a means to streamline and coordinate interactions. These agents facilitate the collective use and management of shared resources, such as items stored in a smart fridge, by multiple users. As a result, device agents have become a critical component in optimizing the user experience within these shared applications. To further enhance the functionality of these device agents, the incorporation of coordinators has become a noteworthy development. Coordinators are designed to augment inputs to device agents, consolidate incoming information, and optimize the output generated by these agents. This orchestration mechanism ensures the efficient functioning of the shared application, promoting smooth user interactions and data management.

In addition to device agents and coordinators, the integration of system agents with fixed interfaces, notably Application Programming Interfaces (APIs), is a key advancement. System agents serve as the communication bridge between various components within the system. The use of standardized interfaces streamlines data exchange and interoperability, enabling seamless communication between diverse elements of the system. Moreover, local agents play a vital role in enhancing the system's capabilities. These agents can determine similarities between different components, track information that has been shared, and implement a throttling mechanism to control the flow of data. This throttling mechanism is especially important in safeguarding the system against potential misuse or exploitation by malicious entities, ensuring the integrity and security of data exchange.

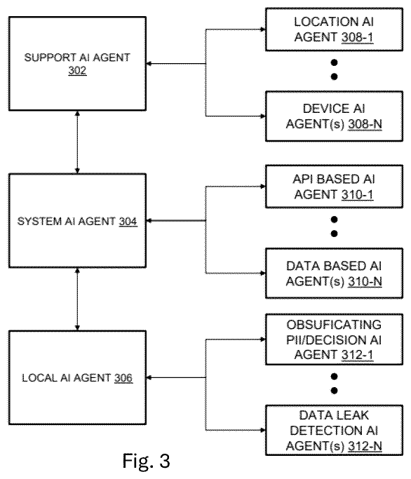

FIG. 3 illustrates an exemplary flow diagram representation of supporting AI agent 302, a system AI agent 304, and a local AI agent 306 including a plurality of artificial intelligence (AI) agents, in accordance with an embodiment of the present disclosure. For example, the support AI agent 302 may include a location AI agent 308-1 and a device AI agent 308-N. Further, the system AI agent 304 may include an application programming interface (API) based AI agent 310-1, and a data based AI agent 310-N. Additionally, the local AI agent 306 may include an obfuscating Personal Identifiable Information (PII)/decision AI agent 312-1, and a data leak detection AI agent(s) 312-N.

For example, the supporting AI agent 302 may be an intelligent component within the system designed to assist and enhance the functionality of the overall system. This agent may have specific tasks or responsibilities that contribute to the system's operations. Typically, supporting AI agents 302 may work in the background, offering support services to other components, users, or AI agents. The supporting AI agents 302 may provide data processing, analysis, recommendations, or any other form of assistance that bolsters the system's performance. The system AI agent 304 may be an integral part of the system, responsible for overseeing and coordinating the broader operations of the system. It may have a comprehensive understanding of the system's objectives and functionalities. This agent can manage interactions between various components or users, control data flow, and ensure that the system operates smoothly and efficiently. The system AI agent 304 may be responsible for decision-making and optimizing the system's performance. Additionally, the local AI agent 306 may be an AI component that operates at a localized level within the system. It is focused on specific tasks or interactions in a particular context. Local AI agents 306 may perform functions such as data analysis, monitoring, or decision-making within their designated area of operation. They may also interact with other local agents or the broader system AI agent to exchange information and coordinate activities within their designated domain.

Since such agents may represent users, services, companies, smart objects, and the like. An example may be within the home such as a fridge outside the home such as an agent in your car.

A fridge for example could take in multiple agents that you use like Amazon, Walmart, where you shop. These agents may give recommendations on which items they would like to “barter” with you on. These negotiations between agents, family members, service agents such as finance agents.

Agents such as Amazon or Walmart may then incentivize you to use their services, such as discounts, but can also provide benefits like other services, take into account Amazon Prime, for cheaper delivery and video services for “free”. Other services may provide future discounts.

There can be a recommender agent that could take in the location, buying history to then make suggestions like an inline ad to suggest purchases for the items in need or suggest purchases for items that the user may be interested in.

This protocol then will form a basis of future value to the user and will be part of the protocol. Previous information, Current information and Future information.

Advertisement systems can make use of this information to “bid” for the users attention to make a transaction.

In accordance with an embodiment of the disclosure, the system AI agent 304, may be configured to a request from a user device for performing a task, wherein the system AI agent 304 processes the request. The system AI agent 304 may be configured to determine a coordinator amongst the number of coordinators configured to augment the request to be implemented with the request. The request and the coordinator may be communicated to the support AI agent 302. The support AI agent 302 may be configured to extract relevant information associated with the request from within the system and outside the system, wherein the relevant information is consolidated by the coordinator. Extracting the relevant information may include maintaining a structured registry containing the relevant information, and performing schema updates and versioning mechanism on relevant information in the registry upon sensing an update in the relevant information. The supporting AI agent may communicate with one or more external applications, the system AI agent 304, and the local AI agent 306 to extract the relevant information. The relevant information may be consolidated by the coordinator by performing a data fusion, a semantic reconciliation, a prioritization and filtering, and an inference consolidation on the relevant information.

The local AI agent 306 may be configured to obfuscate information associated with the system to prevent a data leakage, while the relevant information is being extracted. The system AI agent 304 may be configured to the task associated with the request based on the relevant information, wherein the system AI agent 304 generates an output augmented with another coordinator amongst the number of coordinators.

In an embodiment of the present subject disclosure, the method 400 may include monitoring and managing, by the system AI agent 304, one or more internal functions and one or more internal processes of the system without an external input. The method 400 may include comparing information associated with the supporting AI agent, the system AI agent 304, and the local AI agent 306. The comparison may be performed by the local AI agent 306. Upon comparing the method 400 may include identifying by the local AI agent 306, similarities between the information to optimize a performance while the task is being performed.

In an embodiment of the present disclosure, the method 400 may include implementing, by the system AI agent 304, a throttling mechanism to control a distribution of the relevant information between the supporting AI agent, the system AI agent 304, and the local AI agent 306 within a specific time frame. The method 400 may further include training, by the local AI agent 306, a number of neural network model based on an interaction of the user with the system to predict a number of future interaction of the user with the system as a number of outputs, feeding, by the local AI agent 306, the number of outputs to a meta-learner, wherein the meta learner weighs number of outputs based on a relevance and an accuracy, and generating, by the meta learner, a single output based on weighing the number of outputs, wherein the metal learner received a feedback from the user device based on the output.

### Exemplary Interaction Process Between AI Agents:

The interaction processes within the system involve a sophisticated network of specialized AI agents working collaboratively to ensure seamless functionality. The supporting AI agent 302, which encompasses both the location AI agent 308-1 and the device AI agent 308-N, contributes to the system by providing valuable contextual information related to specific locations and devices. Meanwhile, the system AI agent 304, represented by the API-based AI agent 310-1 and the data-based AI agent 310-N, acts as a central hub that interfaces with external applications and processes large volumes of data. Additionally, the local AI agent 306, comprising the obfuscating Personal Identifiable Information (PII)/decision AI agent 312-1 and the data leak detection AI agent(s) 312-N, operates at a localized level, ensuring data privacy by obfuscating sensitive information and detecting potential leaks. These agents collaborate dynamically, with the supporting AI agent providing context, the system AI agent managing external interfaces, and the local AI agent safeguarding data integrity, creating a robust interaction framework that ensures efficient and secure communication throughout the system.

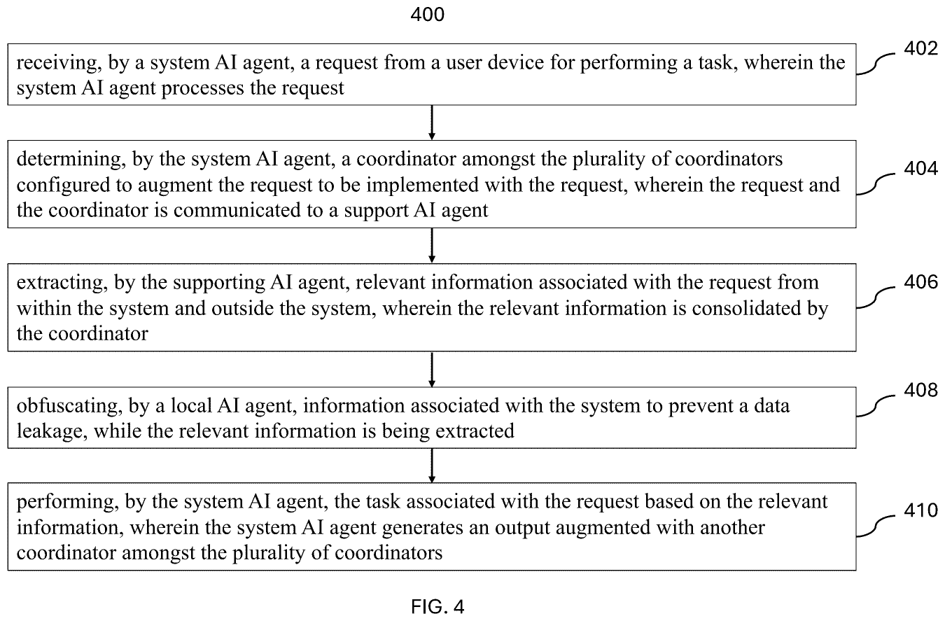

FIG. 4 illustrates an operational flow diagram depicting a method 400 for method for collaborating one or more Artificial Intelligent (AI) agent systems with a number of coordinators to perform a task, in accordance with an embodiment of the present disclosure. The 400 may be performed by the system as referred in FIG. 1.

At step 402, the method 400 may include receiving, by a system AI agent 304, a request from a user device for performing a task, wherein the system AI agent 304 processes the request.

At step 404, the method 400 may include determining, by the system AI agent 304, a coordinator amongst the number of coordinators configured to augment the request to be implemented with the request, wherein the request and the coordinator is communicated to a support AI agent 302. The coordinator may be configured to enhance the request and the output contextually and semantically to assist in a richer decision making. The coordinator may augment the request by performing a contextual enrichment, a semantic normalization, a preference-based enrichment, and a historical pattern recognition.

At step 406, the method 400 may include extracting, by the support AI agent 302, relevant information associated with the request from within the system and outside the system, wherein the relevant information is consolidated by the coordinator. Extracting the relevant information may include maintaining a structured registry containing the relevant information, and performing schema updates and versioning mechanism on relevant information in the registry upon sensing an update in the relevant information. The supporting AI agent may communicate with one or more external applications, the system AI agent 304, and the local AI agent 306 to extract the relevant information. The relevant information may be consolidated by the coordinator by performing a data fusion, a semantic reconciliation, a prioritization and filtering, and an inference consolidation on the relevant information.

At step 408, the method 400 may include obfuscating, by a local AI agent 306, information associated with the system to prevent a data leakage, while the relevant information is being extracted. The local AI agent 306 is configured to monitor behaviour of a user associated with the user device to recognize one or more specific needs of the user and adapt to the one or more specific needs by training based on an interaction of the user with the system to generate a recommendation model, monitoring, by the local AI agent 306, one or more updates in the interaction between the user and the system, and sending the one or more updates to a central server, wherein the one or more updates is aggregated and the recommendation model is improved based on the one or more updates. The recommendation model may be partially trained between the system and the central server. The system may compute one or more initial layers of the recommendation model and transmit intermediate representation associated with the one or more initial layers to the central server for training the recommendation model.

At step 410, the method 400 may include performing, by the system AI agent 304, the task associated with the request based on the relevant information, wherein the system AI agent 304 generates an output augmented with another coordinator amongst the number of coordinators.

In an embodiment of the present subject disclosure, the method 400 may include monitoring and managing, by the system AI agent 304, one or more internal functions and one or more internal processes of the system without an external input. Method 400 may include comparing information associated with the supporting AI agent, the system AI agent 304, and the local AI agent 306. The comparison may be performed by the local AI agent 306. Upon comparing the method 400 may include identifying by the local AI agent 306, similarities between the information to optimize a performance while the task is being performed.

In an embodiment of the present disclosure, the method 400 may include implementing, by the system AI agent 304, a throttling mechanism to control a distribution of the relevant information between the supporting AI agent, the system AI agent 304, and the local AI agent 306 within a specific time frame. The method 400 may further include training, by the local AI agent 306, a number of neural network models based on an interaction of the user with the system to predict a number of future interaction of the user with the system as a number of outputs, feeding, by the local AI agent 306, the number of outputs to a meta-learner, wherein the meta learner weighs number of outputs based on a relevance and an accuracy, and generating, by the meta learner, a single output based on weighing the number of outputs, wherein the metal learner received a feedback from the user device based on the output.

### Exemplary Scenario 1:

Consider, a smart city ecosystem, in which the intricate network of AI agents collaborates seamlessly to ensure the safety and privacy of its citizens. A citizen, equipped with a wearable device, encounters an unexpected medical emergency while in a public location. The support AI agent 302, consisting of the location AI agent 308-1 and the device AI agent 308-N, swiftly identifies the exact location of the individual and triggers an emergency response. Simultaneously, the system AI agent 304, represented by both the API-based AI agent 310-1 and the data-based AI agent 310-N, interfaces with the city's emergency services, providing them with real-time information on the citizen's health status and location.

While this vital communication unfolds, the local AI agent 306 steps in to safeguard the citizen's personal information. The obfuscating Personal Identifiable Information (PII)/decision AI agent 312-1 ensures that the citizen's sensitive data remains confidential throughout the emergency response. Furthermore, the data leak detection AI agent(s) 312-N monitors the communication channels for any potential data breaches or unauthorized access attempts. This intricate interplay of AI agents not only ensures a rapid and effective response to the medical emergency but also prioritizes data privacy and security, exemplifying how AI systems can be harnessed to protect citizens in modern, interconnected urban environments

### Exemplary Scenario 2:

Consider, in a connected household, the utilization of intelligent device agents and AI-driven coordinators has revolutionized the management of everyday tasks. Consider a smart fridge application, where multiple family members have access to the same fridge. Each member can add or remove items and plan their use. Device agents within the fridge application help users keep track of the inventory. For instance, when a user places groceries inside the fridge, a device agent recognizes the items and updates the inventory in real-time.

The system 102 employs coordinators that augment user inputs, ensuring that each item's description is accurate and categorized correctly. Coordinators also consolidate incoming information, such as shopping lists and meal plans, providing a clear overview of the fridge's contents. When a user plans to use an item, the coordinator ensures it's available and updates the shared schedule.

The system 102 is further enhanced by system agents, which communicate through fixed interfaces like APIs. These system AI agents 304 connect the fridge application with other smart appliances in the kitchen, such as the oven and microwave, ensuring seamless coordination when preparing meals. Local AI agent 306 plays a crucial role in the household ecosystem. They compare the fridge's inventory with shopping lists and suggest similar items to save time and reduce food waste. They also keep a record of items added and removed, assisting in expense tracking and making it easy to identify who used what. To prevent any potential misuse, the system incorporates a throttling mechanism. This mechanism controls the frequency and volume of information requests from external systems, safeguarding against malicious entities attempting to overload the system with excessive data queries.

For the sake of brevity, the construction, and operational features of the system 102 which are explained in detail above are not explained in detail herein. Particularly, computing machines such as but not limited to internal/external server clusters, quantum computers, desktops, laptops, smartphones, tablets, and wearables may be used to execute the system 102 or may include the structure of the hardware platform. As illustrated, the hardware platform may include additional components not shown, and some of the components described may be removed and/or modified. For example, a computer system with multiple GPUs may be located on external-cloud platforms including Amazon Web Services® (AWS), internal corporate cloud computing clusters, or organizational computing resources.

The hardware platform may be a computer system such as the system 102 that may be used with the embodiments described herein. The computer system may represent a computational platform that includes components that may be in a server or another computer system. The computer system may be executed by the processor (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor that executes software instructions or code stored on a non-transitory computer-readable storage medium to perform methods of the present disclosure. The software code includes, for example, instructions to gather data and analyze the data as the plurality of modules 114.

The instructions on the computer-readable storage medium are read and stored the instructions in storage or random-access memory (RAM). The storage may provide a space for keeping static data where at least some instructions could be stored for later execution. The stored instructions may be further compiled to generate other representations of the instructions and dynamically stored in the RAM such as RAM. The processor may read instructions from the RAM and perform actions as instructed.

The computer system may further include the output device to provide at least some of the results of the execution as output including, but not limited to, visual information to users, such as external agents. The output device may include a display on computing devices and virtual reality glasses. For example, the display may be a mobile phone screen or a laptop screen. GUIs and/or text may be presented as an output on the display screen. The computer system may further include an input device to provide a user or another device with mechanisms for entering data and/or otherwise interacting with the computer system. The input device may include, for example, a keyboard, a keypad, a mouse, or a touchscreen. Each of these output devices and input devices may be joined by one or more additional peripherals. For example, the output device may be used to display the results such as bot responses by the executable chatbot.

A network communicator may be provided to connect the computer system to a network and in turn to other devices connected to the network including other clients, servers, data stores, and interfaces, for example. A network communicator may include, for example, a network adapter such as a LAN adapter or a wireless adapter. The computer system may include a data source interface to access the data source. The data source may be an information resource. As an example, a database of exceptions and rules may be provided as the data source. Moreover, knowledge repositories and curated data may be other examples of the data source.

Embodiments of the present disclosure provide collaborative artificial intelligent (AI) agent systems with coordinators for shared applications and methods thereof. By leveraging device agents, the present disclosure enables the seamless participation of multiple users in shared applications, such as the example of a smart fridge application. Users can effortlessly contribute items to the application and plan their usage, resulting in enhanced collaboration and convenience. The introduction of coordinators within the system brings efficiency to a new level. Coordinators augment inputs to device agents, consolidate incoming information, and streamline output, ensuring that collaborative functions within the shared application operate smoothly. This not only optimizes user experiences but also prevents conflicts and data inconsistencies.

Furthermore, the integration of system agents with fixed interfaces, such as APIs, promotes interoperability and standardized communication between different components of the system. This standardized approach enhances the system's flexibility and ease of integration with various devices and services. Local agents play a critical role in maintaining data integrity and security. They are adept at comparing information between agents, identifying similarities, and keeping records of shared data. Additionally, the implementation of a throttling mechanism prevents malicious activities by controlling the flow of information, safeguarding against excessive requests, and ensuring the protection of shared data.

The written description describes the subject matter herein to enable any person skilled in the art to make and use the embodiments. The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

We claim:

1. A method for collaborating one or more Artificial Intelligent (AI) agent systems with a plurality of coordinators, the method comprising:
receiving, by a system AI agent, a request from a user device for performing a task, wherein the system AI agent processes the request;
determining, by the system AI agent, a coordinator amongst the plurality of coordinators configured to augment the request to be implemented with the request, wherein the request and the coordinator is communicated to a support AI agent;
extracting, by the support AI agent, relevant information associated with the request from within the system and outside the system, wherein the relevant information is consolidated by the coordinator;
obfuscating, by a local AI agent, information associated with the system to prevent a data leakage, while the relevant information is being extracted; and
performing, by the system AI agent, the task associated with the request based on the relevant information, wherein the system AI agent generates an output augmented with another coordinator amongst the plurality of coordinators.

2. The method according to claim 1, wherein extracting the relevant information comprises:
maintaining a structured registry containing the relevant information; and
performing schema updates and versioning mechanism on relevant information in the registry upon sensing an update in the relevant information.

3. The method according to claim 1, comprising:
monitoring and managing, by the system AI agent, one or more internal functions and one or more internal processes of the system without an external input.

4. The method according to claim 1, comprising:
comparing, by the local AI agent, information associated with the supporting AI agent, the system AI agent, and the local AI agent;
identifying, by the local AI agent, similarities between the information to optimize a performance while the task is being performed.

5. The method according to claim 1, further comprising:
implementing, by the system AI agent, a throttling mechanism to control a distribution of the relevant information between the supporting AI agent, the system AI agent, and the local AI agent within a specific time frame.

6. The method according to claim 1, wherein the supporting AI agent communicates with one or more external applications, the system AI agent, and the local AI agent to extract the relevant information.

7. The method according to claim 1, wherein the local AI agent is configured to monitor behaviour of a user associated with the user device to recognize one or more specific needs of the user and adapt to the one or more specific needs by:
training, by the local AI agent, based on an interaction of the user with the system to generate a recommendation model;
monitoring, by the local AI agent, one or more updates in the interaction between the user and the system; and
sending, by the local AI agent, the one or more updates to a central server, wherein the one or more updates is aggregated and the recommendation model is improved based on the one or more updates.

8. The method according to claim 7, wherein the recommendation model is partially trained between the system and the central server, wherein the system computes one or more initial layers of the recommendation model and transmits intermediate representation associated with the one or more initial layers to the central server for training the recommendation model.

9. The method according to claim 1, wherein the coordinator is configured to enhance the request and the output contextually and semantically to assist in a richer decision making.

10. The method according to claim 1, wherein the coordinator augment the request by performing a contextual enrichment, a semantic normalization, a preference-based enrichment, and a historical pattern recognition.

11. The method according to claim 1, wherein the relevant information is consolidated by the coordinator by performing a data fusion, a semantic reconciliation, a prioritization and filtering, and an inference consolidation on the relevant information.

12. The method according to claim 1, further comprising:
training, by the local AI agent, a plurality of neural network model based on an interaction of the user with the system to predict a plurality of future interaction of the user with the system as a plurality of outputs;
feeding, by the local AI agent, the plurality of outputs to a meta-learner, wherein the meta learner weighs plurality of outputs based on a relevance and an accuracy; and
generating, by the meta learner, a single output based on weighing the plurality of outputs, wherein the metal learner receives feedback from the user device based on the output.

13. A system for collaborating one or more Artificial Intelligent (AI) agent systems with a plurality of coordinators, the system comprising:
a system AI agent configured to:
receive a request from a user device for performing a task, wherein the system AI agent processes the request;
determine a coordinator amongst the plurality of coordinators configured to augment the request to be implemented with the request, wherein the request and the coordinator is communicated to a support AI agent;
the support AI agent configured to extract relevant information associated with the request from within the system and outside the system, wherein the relevant information is consolidated by the coordinator;
a local AI agent configured to obfuscate information associated with the system to prevent a data leakage, while the relevant information is being extracted;
the system AI agent configured to perform the task associated with the request based on the relevant information, wherein the system AI agent generates an output augmented with another coordinator amongst the plurality of coordinators.

14. A non-transitory machine-readable medium including data, which when used by a system for collaborating one or more Artificial Intelligent (AI) agent systems with a plurality of coordinators, causes the system to perform instructions that cause the system to perform operations comprising:
receiving, by a system AI agent, a request from a user device for performing a task, wherein the system AI agent processes the request;
determining, by the system AI agent, a coordinator amongst the plurality of coordinators configured to augment the request to be implemented with the request, wherein the request and the coordinator is communicated to a support AI agent;
extracting, by the support AI agent, relevant information associated with the request from within the system and outside the system, wherein the relevant information is consolidated by the coordinator;
obfuscating, by a local AI agent, information associated with the system to prevent a data leakage, while the relevant information is being extracted; and
performing, by the system AI agent, the task associated with the request based on the relevant information, wherein the system AI agent generates an output augmented with another coordinator amongst the plurality of coordinators.
